(19) United States
(12) Patent Application Publication
(10) Pub. No.: US 2022/0381205 A1
(43) Pub. Date: Dec. 1, 2022

(54) VALVE ASSEMBLY FOR VEHICLE EXHAUST SYSTEM

(71) Applicant: Faurecia Emissions Control Technologies, USA, LLC, Columbus, IN (US)

(72) Inventors: Francois FERNAND, Augsburg (DE); Valentin SAGE--AUBRIOT, Auxon-les-Vesoul (FR); Joseph CALLAHAN, Greenwood, IN (US)

(21) Appl. No.: 17/329,624

(22) Filed: May 25, 2021

(51) Int. Cl. F02M 26/72; F02M 26/22; F16K 11/072

(52) U.S. Cl. CPC F02M 26/72; F02M 26/22; F16K 11/072

(57) ABSTRACT

A vehicle exhaust component assembly, according to an exemplary aspect of the present disclosure includes, among other things, a valve housing having a first opening associated with a heat exchanger and a second opening associated with a bypass, and a valve body mounted for pivoting movement within the valve housing between at least a first position and a second position,. The valve body has a first side and a second side opposite the first side. A first flap is mounted on the first side and is to be associated with the first opening. A second flap is mounted on the second side and is to be associated with the second opening.

### TECHNICAL FIELD

This disclosure relates generally to the field of vehicle exhaust systems, and more particularly to a valve assembly used in such exhaust systems.

### BACKGROUND

A vehicle exhaust system includes various components to reduce emissions and control noise. In certain exhaust system applications, an Exhaust Gas Recirculation (EGR) system and/or an Exhaust Heat Recovery System (EHRS) are also utilized. The EGR is a system that allows the exhaust gases to be recirculated back into an engine intake manifold to reduce nitrogen oxides (NOx) emissions. In one example system, the exhaust gases are recirculated back into the engine intake manifold by using an external duct and an EGR valve. The EHRS captures thermal energy from the exhaust gas and transfers the thermal energy to another fluid such as engine coolant, for example. Providing a valve assembly to work with both systems presents challenges.

### SUMMARY

A vehicle exhaust component assembly, according to an exemplary aspect of the present disclosure includes, among other things, a valve housing having a first opening associated with a heat exchanger and a second opening associated with a bypass, and a valve body mounted for pivoting movement within the valve housing between at least a first position and a second position. The valve body has a first side and a second side opposite the first side. A first flap is mounted on the first side and is to be associated with the first opening. A second flap is mounted on the second side and is to be associated with the second opening.

In a further non-limiting embodiment of the foregoing vehicle exhaust component assembly, the first flap comprises a first spherical flap and the second flap comprises a second spherical flap.

In a further non-limiting embodiment of any of the foregoing vehicle exhaust component assemblies, the second spherical flap is connected to the first spherical flap via a shaft portion that extends through a body opening in the valve body, and the assembly includes a compliant member surrounding the shaft portion within the body opening and extending between the first spherical flap and the first side of the valve body and extending between the second spherical flap and the second side of the valve body.

In a further non-limiting embodiment of any of the foregoing vehicle exhaust component assemblies, the first flap comprises a conical flap and has an increasing outer dimension in a direction extending away from the first opening.

In a further non-limiting embodiment of any of the foregoing vehicle exhaust component assemblies, the second flap comprises a flat flap.

In a further non-limiting embodiment of any of the foregoing vehicle exhaust component assemblies, the flat flap has a ring shape that directly seals against a pipe planar end of the bypass when in the second position.

In a further non-limiting embodiment of any of the foregoing vehicle exhaust component assemblies, a pivot shaft is mounted within the valve housing, and wherein the valve body comprises a vane that is fixed for pivoting movement with the pivot shaft, and including a second shaft that extends between the first flap and the vane.

In a further non-limiting embodiment of any of the foregoing vehicle exhaust component assemblies, the second shaft has a first end associated with the first flap and a second end associated with the vane, wherein the second end comprises a spherical ball portion that fits within a spherical recess in the vane to allow the second shaft to pivot relative to the vane.

In a further non-limiting embodiment of any of the foregoing vehicle exhaust component assemblies, a compliant member is mounted around the second shaft adjacent to the spherical ball portion.

In a further non-limiting embodiment of any of the foregoing vehicle exhaust component assemblies, a compliance housing encloses the compliant member between an inner surface of the compliance housing and the first side of the vane.

In a further non-limiting embodiment of any of the foregoing vehicle exhaust component assemblies, the compliant member comprises a wire mesh ring.

In a further non-limiting embodiment of any of the foregoing vehicle exhaust component assemblies, an EGR system has an EGR pipe connected to an outlet from the heat exchanger and an EGR valve that is moveable between an open position to allow exhaust gas flow into the EGR pipe and a closed position to prevent exhaust gas flow in the EGR pipe.

In a further non-limiting embodiment of any of the foregoing vehicle exhaust component assemblies, when the first flap seals the first opening and when the EGR valve is in the open position, exhaust gas flows through the heat exchanger to be cooled before entering the EGR pipe, and exhaust gas also flows through the bypass and into a downstream component; and when the first flap seals the first opening and when the EGR valve is in the closed position, exhaust gas only flows through the bypass.

In a further non-limiting embodiment of any of the foregoing vehicle exhaust component assemblies, when the second flap seals the second opening and when the EGR valve is in the open position, exhaust gas flows through the heat exchanger to be cooled before entering the EGR pipe, exhaust gas is prevented from flowing through the bypass, and exhaust gas flows through the heat exchanger and is subsequently directed into the downstream component; and when the second flap seals the second opening and when the EGR valve is in the closed position, exhaust gas only flows through the heat exchanger and then into the downstream component, and exhaust gas is prevented from flowing through the bypass.

A vehicle exhaust component assembly, according to yet another exemplary aspect of the present disclosure includes, among other things, an EHRS including a heat exchanger having an exchanger inlet and an exchanger outlet, and an EGR system having an EGR pipe in communication with the heat exchanger outlet and an EGR valve moveable between an open position to allow exhaust gas flow into the EGR pipe and a closed position to prevent exhaust gas flow in the EGR pipe. A bypass tube is in parallel with the heat exchanger and has a bypass inlet that receives engine exhaust gases and which is in communication with the exchanger inlet, and a bypass outlet that directs the engine exhaust gases into a downstream component. A valve housing includes a first opening associated with the exchanger outlet, a second opening associated with the bypass outlet, and a third opening associated with an inlet to the downstream component. A valve body is mounted for pivoting movement within the valve housing, wherein the valve body has a first side and a second side opposite the first side, and wherein the valve body is moveable between at least a first position to close the first opening and a second position to close the second opening. A first flap is mounted on the first side to close the first opening and a second flap is mounted on the second side and is associated with the second opening.

In a further non-limiting embodiment of any of the foregoing vehicle exhaust component assemblies, the first flap comprises a conical flap and the second flap comprises a flat flap.

In a further non-limiting embodiment of any of the foregoing vehicle exhaust component assemblies, a pivot shaft is mounted within the valve housing, and wherein the valve body comprises a vane that is fixed for pivoting movement with the pivot shaft, and including a second shaft that extends between the first flap and the vane, wherein the second shaft has a first end associated with the first flap and a second end associated with the vane, wherein the second end comprises a spherical ball portion that fits within a spherical recess in the vane to allow the second shaft to pivot relative to the vane.

In a further non-limiting embodiment of any of the foregoing vehicle exhaust component assemblies, a compliant member is mounted around the second shaft adjacent to the spherical ball portion and a compliance housing encloses the compliant member between an inner surface of the compliance housing and the first side of the vane.

In a further non-limiting embodiment of any of the foregoing vehicle exhaust component assemblies, the first flap comprises a first spherical flap and the second flap comprises a second spherical flap, wherein the second spherical flap is connected to the first spherical flap via a shaft portion that extends through a body opening in the valve body, and including a compliant member surrounding the shaft portion within the body opening and extending between the first spherical flap and the first side of the valve body and extending between the second spherical flap and the second side of the valve body.

In a further non-limiting embodiment of any of the foregoing vehicle exhaust component assemblies, when the first flap seals the first opening and when the EGR valve is in the open position, exhaust gas flows through the heat exchanger to be cooled before entering the EGR pipe, and exhaust gas also flows through the bypass tube and into the downstream component; when the first flap seals the first opening and when the EGR valve is in the closed position, exhaust gas only flows through the bypass; when the second flap seals the second opening and when the EGR valve is in the open position, exhaust gas flows through the heat exchanger to be cooled before entering the EGR pipe, exhaust gas is prevented from flowing through the bypass tube, and exhaust gas flows through the heat exchanger and is subsequently directed into the downstream component; and when the second flap seals the second opening and when the EGR valve is in the closed position, exhaust gas only flows through the heat exchanger and then into the downstream component, and exhaust gas is prevented from flowing through the bypass tube.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 schematically illustrates one example of an exhaust system according to the subject disclosure.

FIG. 2 is a side perspective view of a valve assembly as used in the system of FIG. 1.

FIG. 3 is a bottom perspective view of the valve assembly of FIG. 2.

FIG. 4 is a section view of the valve assembly of FIG. 2.

FIG. 5 is a perspective view of a first flap from the valve assembly of FIG. 2.

FIG. 6 is a perspective view of a compliance housing from the valve assembly of FIG. 2.

FIG. 7 is a perspective view of a compliant member from the valve assembly of FIG. 2.

FIG. 8 is a perspective view of a valve shaft from the valve assembly of FIG. 2.

FIG. 9 is a perspective view of a vane from the valve assembly of FIG. 2.

FIG. 10 is a section view of the first flap closing an outlet from a heat exchanger from the system of FIG. 1.

FIG. 11 is schematic illustration of another example of a valve assembly as used in the system of FIG. 1.

FIG. 12 is a side view of a double-mushroom shaped valve configuration as shown in FIG. 11.

### DETAILED DESCRIPTION

This disclosure details an exemplary valve assembly for a vehicle exhaust system that includes an EHRS and an EGR system.

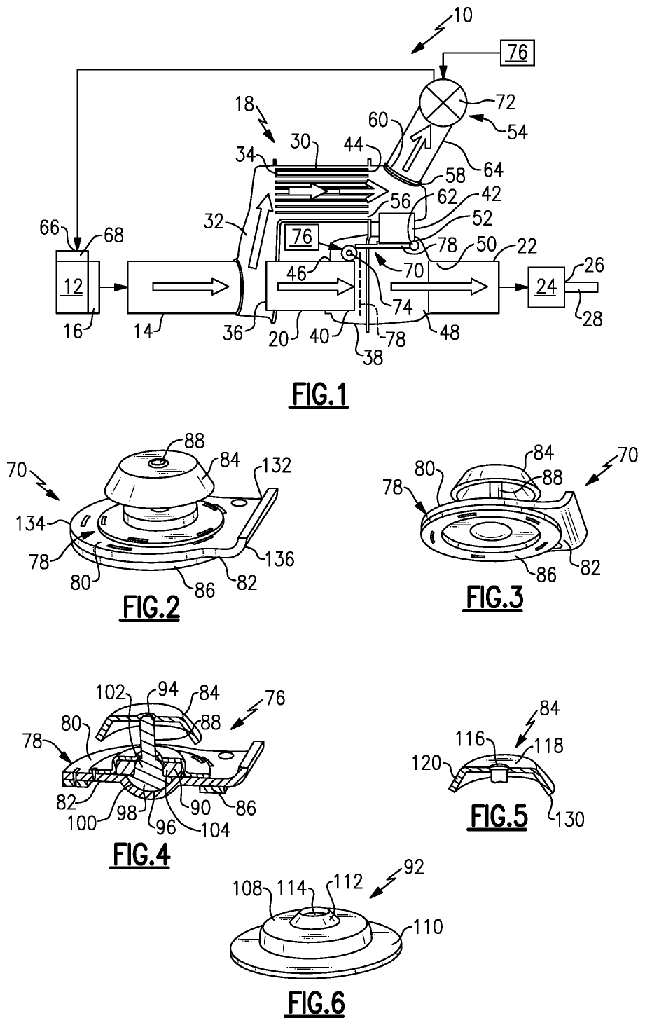

FIG. 1 shows a vehicle exhaust system 10 that conducts hot exhaust gases generated by an engine 12 through various exhaust components to reduce emission and control noise. In one example configuration, at least one pipe 14 directs engine exhaust gases exiting an exhaust manifold 16 of the engine 12 into an EHRS 18 or a bypass tube 20 that avoids the EHRS 18. The bypass tube 20 feeds into another tube or pipe 22 that leads to one or more downstream exhaust gas aftertreatment components 24. The exhaust gas aftertreatment components 24 can include a diesel oxidation catalyst (DOC), an optional diesel particulate filter (DPF) that is used to remove contaminants from the exhaust gas, a mixer, and/or a selective catalytic reduction (SCR) catalyst, for example. An outlet 26 from the downstream exhaust gas aftertreatment components 24 communicates exhaust gases to atmosphere via a tailpipe 28.

In one example, the EHRS 18 includes a heat exchanger 30 that allows the exchange of heat between the exhaust gases, passing through the heat exchanger 30, and a heat transfer fluid, such as a coolant for example. The heat exchanger 30 is arranged in parallel with the bypass tube 20. An inlet tube 32 connects an inlet 34 to the heat exchanger 30 to an inlet opening 36 to the bypass tube 20 and to an opening in the upstream pipe 14. A valve housing 38 connects an outlet opening 40 from the bypass tube 20 to the downstream pipe 22. The valve housing 38 is also connected to an outlet tube 42 that is connected to an outlet 44 from the heat exchanger 30. As such, the valve housing 38 includes a first opening 46 associated with the outlet opening 40 from the bypass tube 20, a second opening 48 associated with an inlet 50 to the downstream pipe 22, and a third opening 52 associated with the outlet tube 42.

In one example, an EGR system 54 is connected to the outlet tube 42. Thus, the outlet tube 42 has a first opening 56 associated with the outlet 44 from the heat exchanger 30, a second opening 58 associated within an inlet 60 to the EGR system 54, and a third opening 62 associated with the third opening 52 of the valve housing 38. The EGR system 54 includes at least one duct, tube, or pipe 64 that connects the inlet 60 to the EGR system 54 to an inlet 66 to an intake manifold 68 for the engine 12.

A valve assembly 70 is installed within the valve housing 38 to control flow between the EHRS 18 and the bypass tube 20. An EGR valve 72 is installed within the EGR pipe 64 to control when the exhaust gases are to be recirculated back into the engine intake manifold 68. The EGR valve 72 is a separate valve from the valve assembly 70. When the EGR valve 72 is closed, exhaust gases are prevented from entering the EGR pipe 64 and when the EGR valve 72 is open, exhaust gases are allowed to enter the EGR pipe 64 to be recirculated back to the intake manifold 68.

The valve assembly 70 is mounted on a pivot shaft 74 that is installed within the valve housing 38. The valve assembly 70 pivots between at least a first position shown in FIG. 1 and a second position shown in dashed lines in FIG. 1. In the first position, the valve assembly 70 closes and seals the third opening 52 of the valve housing 38 and therefore also closes the third opening 62 of the outlet tube 42. In the second position, the valve assembly closes 70 the outlet opening 40 from the bypass tube 20.

When in the valve assembly 70 is in the first position, and if the EGR valve 72 is open, exhaust gas can flow through the heat exchanger 30 to be cooled before entering the EGR pipe 64 to be recirculated to the intake manifold 68. The exhaust gas also continues to flow through the bypass tube 20 and into the downstream pipe 22. When in the valve assembly 70 is in the first position, and if the EGR valve 72 is closed, exhaust gas only flows through the bypass tube 20.

When in the valve assembly 70 is in the second position, and if the EGR valve 72 is open, exhaust gas can flow through the heat exchanger 30 to be cooled before entering the EGR pipe 64 to be recirculated to the intake manifold 68. Exhaust gas is prevented from flowing through the bypass tube 20. Exhaust gas can also flow through the heat exchanger 30 and enter the outlet tube 42 where it can then be redirected into the downstream pipe 22. When in the valve assembly 70 is in the second position, and if the EGR valve 72 is closed, exhaust gas only flows through the heat exchanger 30 and then the outlet tube 42 where it is then directed into the downstream pipe 22. Exhaust gas is prevented from flowing through the bypass tube 20.

A control system includes a controller 76 that controls the valve assembly 70 and the EGR valve 72. The controller 76 can be a dedicated common electronic control unit or can be an electronic control unit associated with a vehicle system control unit or sub-system control unit. Each valve may also have its own dedicated controller 76. The controller 76 can include a processor, memory, and one or more input and/or output (I/O) device interface(s) that are communicatively coupled via a local interface. The controller 76 may be a hardware device for executing software, particularly software stored in memory that opens and closes the valves 70, 72 to achieve desired operational conditions.

FIGS. 2-9 show the valve assembly 70 in greater detail. In one example, the valve assembly 70 includes a valve or vane body 78 that is mounted for pivoting movement within the valve housing 38 via the pivot shaft 74. The vane body 78 has a first side 80 and a second side 82 that is opposite from the first side 80. In one example, a first flap 84 is mounted on the first side 80 and a second flap 86 is mounted on the second side 82. The first flap 84 is to be associated with the opening 52 in the valve housing that is associated with the outlet 44 from the heat exchanger 30. The second flap 86 is to be associated with the outlet opening 40 from the bypass tube 20.

In one example, the valve assembly 70 also includes a valve shaft 88 that connects the first flap 84 to the vane body 78, a compliant member 90, and a compliance housing 92 for the compliant member 90. The valve shaft 88 has a first end 94 coupled to the first flap 84 and a second end 96 coupled to the vane body 78. In one example, the second end 96 comprises a spherical ball portion 98 that fits within a spherical recess 100 in the vane body 78 to allow the valve shaft 88 to pivot relative to the vane body 78 (FIG. 4). This ball joint configuration allows a small angle of rotation, which facilitates positioning the first flap 84 with regard to the associated sealing interface and compensates for some misalignment during the assembly process or due to manufacturing tolerances of the components.

In one example shown in FIG. 8, the valve shaft 88 is defined by a first dimension at the first end 94 and transitions into a portion 102 that has a second dimension that is greater than the first dimension. The portion 102 then transitions into the spherical ball portion 98 at the second end 96. A lip or ledge 104 is formed at a transition between the portion 102 and the spherical ball portion 98.

In one example, the compliant member 90 is mounted around the valve shaft 88 adjacent to the spherical ball portion 98. In one example, the compliant member 90 comprises a ring-shaped member having a first side 105 and a second side 106 (FIG. 7). In the example shown in FIG. 4, the second side 106 of the compliant member 90 sits on the ledge 104 of the valve shaft 88. The compliant member 90 includes an opening 107 through which the valve shaft 88 extends. In one example, the compliant member 90 is made from a wire mesh or other similar material that is capable of absorbing and damping vibrations to reduce any rattling noise that may be generated during operation of the valve assembly 70.

In one example, the compliance housing 92 encloses the compliant member 90 between an inner surface of the compliance housing 92 and the first side 80 of the vane body 78. This mounting arrangement holds the compliant member 90 in place and seats the compliant member 90 against the ledge 104 of the valve shaft 88. This allows the compliant member 90 to absorb and dampen vibrations as well as allowing the spherical ball portion 98 to pivot within a defined range of motion within the compliance housing 92.

In one example shown in FIG. 6, the compliance housing 92 comprises a cup-shaped portion 108 and an outer peripheral flange 110 that sits flat against the vane body 78. A boss portion 112 extends outwardly of a bottom surface of the cup-shaped portion 108 and includes an opening 114 through which the valve shaft 88 extends. The outer peripheral flange 110 extends radially outward of an opposite end of the cup-shaped portion from the boss portion 112.

As shown in FIG. 5, the first flap 84 comprises a conical flap that includes an opening 116 that receives the first end 94 of the valve shaft 88. In one example, the conical flap 84 has a generally flat base portion 118 that includes the opening 116 and a tapering body portion 120 that extends away from the base portion 118. The tapering body portion 120 has an increasing outer dimension that extends in a direction toward the vane body 78 and terminates at a distal edge 130. The distal edge 130 is spaced apart from the compliance housing 92 and the vane body 78 due to the length of the valve shaft 88 as shown in FIG. 10.

In one example, a flat plate 122 is mounted to an inner surface 124 of the valve housing 78 as shown in FIG. 10. The plate 122 includes a plate opening 126 that is aligned with the opening 52 in the valve housing 38. In one example, the opening 126 is circular. In the example shown, the conical flap 84 extends at least partially through the plate opening 126 to seal directly against the plate 122 at the plate opening 126. This provides for a line contact between a sealing lip of the plate 122 and the cone-shaped flap 84 to reduce leakage as much as possible. The conical shape also provides some flexibility in order to compensate for any misalignment during the assembly process or due to manufacturing tolerances of the components.

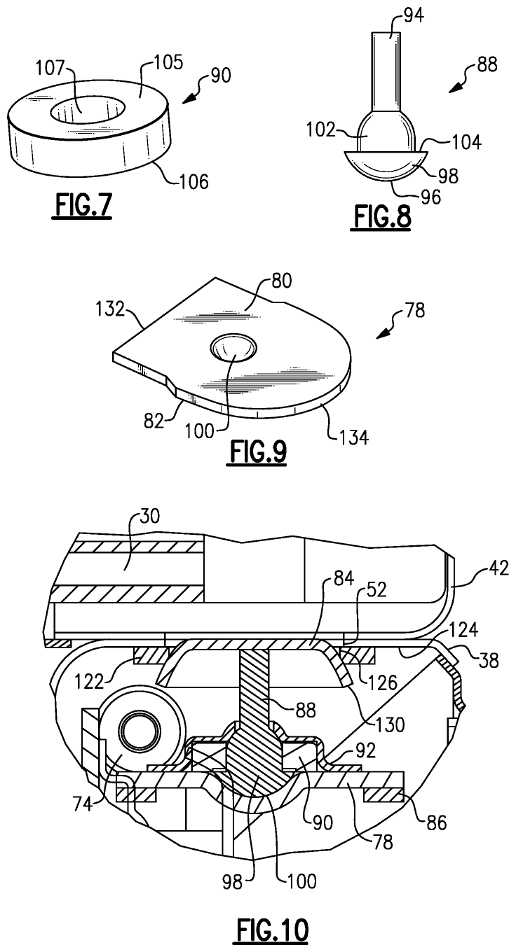

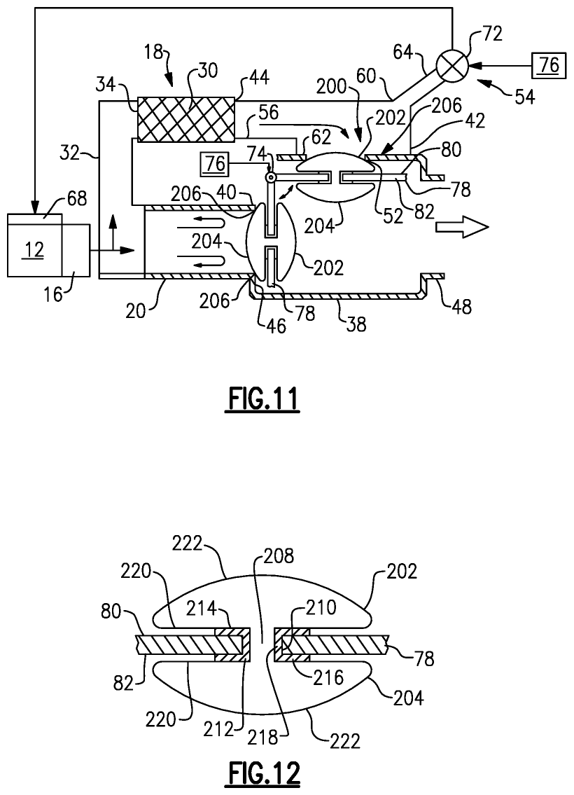

In one example shown in FIG. 9, the vane body 78 comprises a generally flat plate extending between a first edge 132 and an opposite edge 134. The first edge 132 is fixed to the pivot shaft 74. In one example shown in FIG. 2, the first edge 132 includes a curved portion 136 that fits around the shaft 74. The vane body 78 comprises a straight portion at the first edge 132 that transitions into a rounded portion at the opposite edge 134. In one example, the rounded portion comprises a circular plate that is configured to cover the outlet opening 40 from the bypass tube 20. In one example, the outlet opening 40 is a circular opening. The rounded portion also includes the recess 100 that receives the spherical ball portion 98 of the valve shaft 88.

In one example, the second flap 86 comprises a flat flap that is mounted to the second side 82 of the vane body 78 at the rounded portion. In one example, the flat flap 86 has a ring shape (FIG. 3) that directly seals against a pipe planar end of the bypass tube 20 as shown in the dashed lines of FIG. 1.

In another example shown in FIG. 11, a valve assembly 200 includes a first flap 202 on one side 80 of the vane body 78 and a second flap 204 on the opposite side 82 of the vane body 78. The first flap 202 is configured to engage the opening 52 in the valve housing 38 associated with the EGR system 54 and the second flap 204 is configured to engage the opening 40 in the bypass tube 20 associated with the opening 46 in the valve housing 38. In one example, the opening 52 in the valve housing 38 and the opening 40 in the bypass tube are circular openings.

In one example, the first flap 202 comprises a first spherical flap and the second flap 204 comprises a second spherical flap. The first and second spherical flaps 202, 204 comprise half spheres or hemispheres that face their respective openings 52, 40 such that when engaged with the openings 52, 40 there is line contact as indicated at 206. By using a half sphere to contact a round opening in a valve body, a single line of contact is created to provide a tight seal. Movement of the valve assembly 200 between the first and second positions to cover the associated openings is the same as that described above with regard to valve assembly 70.

In this example, the second spherical flap 204 is connected to the first spherical flap 202 by a shaft portion 208. The shaft portion 208 has a significantly smaller cross-section relative to the cross-sections of the spherical flaps 202, 204, which forms a narrow neck between the flaps and comprises a double-mushroom shape. The vane body 78 includes a body opening 210 through which the shaft portion 208 extends such that the first spherical flap 202 is on one side 80 of the vane body 78 and the second spherical flap 204 is on an opposite side 82 of the vane body 78.

In one example, a compliant member 212 is inserted between the vane body 78 and the flaps 202, 204. The compliant member 212 also extends through the opening 210 in the vane body 78 and surrounds the shaft portion 208 within the opening 210. In one example shown in FIG. 12, the compliant member 212 comprises a first flat disc portion 214 that is directly between the first spherical flap 202 and the surface 80 of the vane body, a second flat disc portion 216 that is directly between the second spherical flap 204 and the surface 82 of the vane body 78, and a narrow neck portion 218 that connects the first 214 and second 216 flat disc portions. The hemisphere shape of the flaps 202, 204 provides a flat surface portion 220, which is opposite the spherical surface portion 222. The first 214 and second 216 flat disc portions fit against the flat surface portions 220. To allow for relative movement between the two spherical surface portions 222 to facilitate good contact, the two spherical surface portions 222 are allowed some relative motion via the compliant member 212 that is inserted between the vane body 78 and the flaps 202, 204. In one example, the compliant member 212 is comprised of a wire mesh or other similar material.

The subject disclosure provides for an EHRS 18 combined with an EGR system 54, where the valve assembly 70, 200 is configured to reduce any leakage back toward the heat exchanger 30 as much as possible. Low leakage is required in order to keep the exhaust gas temperature for the EGR recirculation below at least 160° C., which is an example temperature limit for the EGR valve 72 at the intake manifold 68. As such, in one example, the target for temperature of exhaust gases after the heat exchanger 30 of the EHRS 18 should be around 130° C. The valve assembly 70, 200 provides good sealing such that the leakage is as low as possible in order to keep the exhaust gas as cool as possible after the heat exchanger 30. In one example there is a target of 2.2 kg/h at 860° C., for 55 kg/h going through the heat exchanger 30.

In one example, the subject disclosure accomplishes this by providing the valve assembly 70, 200 with two separate flaps, with one flap on each side of the valve body. One flap is configured to close the bypass tube 20, while the other flap is configured for interaction with the EGR path and consequently provides the low leakage interface. The subject valve assembly 70, 200 is also easy to assemble and provides flexibility to adjust with tolerances.

Additionally, the subject disclosure provides for a valve housing 38, which in one example, is associated with two round openings: a first opening 40 embodied by a pipe planar end of the bypass tube 20 and a second opening 126 embodied by a cut out in a plate 122 or an opening in the housing itself. The vane body 78 is configured to close the two openings by being articulated between two different positions via the pivot lever shaft 74. The subject vane body provides two different closure elements and includes a compliant insert 90, 212 that allows for multi-rotational movement. The compliant insert 90, 212 accommodates possible misalignment between the lever shaft 74 and the two openings to be closed, as well as reducing the noise associated vibrations generated by operation of the valve assembly 70.

In one example, the flaps are made from metallic material, which can introduce an undesirable noise effect during closing of the associated flap against a pipe or housing opening. This metal to metal contact noise can be offset by employing an actuator strategy via the controller 76 that slows the movement of the vane down significantly just prior to contact to minimize the impact.

Although a specific component relationship is illustrated in the figures of this disclosure, the illustrations are not intended to limit this disclosure. In other words, the placement and orientation of the various components shown could vary within the scope of this disclosure. In addition, the various figures accompanying this disclosure are not necessarily to scale, and some features may be exaggerated or minimized to show certain details of a particular component.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

1. A vehicle exhaust component assembly comprising:
a valve housing including a first opening associated with a heat exchanger and a second opening associated with a bypass;
a valve body mounted for pivoting movement within the valve housing between at least a first position and a second position, wherein the valve body has a first side and a second side opposite the first side;
a first flap mounted on the first side, the first flap comprising a conical flap to be associated with the first opening;
a second flap mounted on the second side, the second flap comprising a flat flap to be associated with the second opening;
a pivot shaft mounted within the valve housing, and wherein the valve body comprises a vane that is fixed for pivoting movement with the pivot shaft; and
a second shaft that extends between the first flap and the vane, wherein the second shaft has a first end associated with the first flap and a second end associated with the vane, wherein the second end comprises a spherical ball portion that fits within a spherical recess in the vane to allow the second shaft to pivot relative to the vane.

2-3. (canceled)

4. The vehicle exhaust component assembly according to claim 1, including an outlet tube that is connected to an outlet from the heat exchanger and is associated with the first opening of the valve housing, and wherein the conical flap has an increasing outer dimension in a direction extending away from the first opening when the first flap closes an end of the outlet tube.

5. The vehicle exhaust component assembly according to claim 1, wherein the flat flap has a ring shape having an outer peripheral edge that aligns with an outer peripheral edge of a circular portion of the vane such the flat flap directly seals against a pipe planar end of a bypass tube that provides the bypass.

6. The vehicle exhaust component assembly according to claim 1, wherein the flat flap has a ring shape that directly seals against a pipe planar end of the bypass when in the second position.

7-8. (canceled)

9. The vehicle exhaust component assembly according to claim 1, including a compliant member mounted around the second shaft adjacent to the spherical ball portion.

10. The vehicle exhaust component assembly according to claim 9, including a compliance housing enclosing the compliant member between an inner surface of the compliance housing and the first side of the vane.

11. The vehicle exhaust component assembly according to claim 9, wherein the compliant member comprises a wire mesh ring.

12. The vehicle exhaust component assembly according to claim 1, including an outlet tube that is connected to a first outlet from the heat exchanger and is associated with the first opening of the valve housing, and including an EGR system having an EGR pipe connected to a second outlet from the heat exchanger and an EGR valve moveable between an open position to allow exhaust gas flow into the EGR pipe and a closed position to prevent exhaust gas flow in the EGR pipe.

13. The vehicle exhaust component assembly according to claim 12, wherein:
when the first flap seals the outlet tube and when the EGR valve is in the open position, exhaust gas flows through the heat exchanger to be cooled before entering the EGR pipe, and exhaust gas also flows through the bypass and into a downstream component; and
when the first flap seals the outlet tube and when the EGR valve is in the closed position, exhaust gas only flows through the bypass.

14. The vehicle exhaust component assembly according to claim 13, including a bypass tube that is associated with the second opening of the valve housing, and wherein:
when the second flap seals the bypass tube and when the EGR valve is in the open position, exhaust gas flows through the heat exchanger to be cooled before entering the EGR pipe, exhaust gas is prevented from flowing through the bypass, and exhaust gas flows through the heat exchanger and is subsequently directed into the downstream component; and
when the second flap seals the bypass tube and when the EGR valve is in the closed position, exhaust gas only flows through the heat exchanger and then into the downstream component, and exhaust gas is prevented from flowing through the bypass.

15. A vehicle exhaust component assembly comprising:
an EHRS including a heat exchanger having an exchanger inlet, a first exchanger outlet, and a second exchanger outlet;
an EGR system having an EGR pipe in communication with the first exchanger outlet and an EGR valve moveable between an open position to allow exhaust gas flow into the EGR pipe and a closed position to prevent exhaust gas flow in the EGR pipe;
an outlet tube that is connected to the second exchanger outlet;
a bypass tube in parallel with the heat exchanger and having a bypass inlet that receives engine exhaust gases and which is in communication with the exchanger inlet, and a bypass outlet that directs the engine exhaust gases into a downstream component;
a valve housing including a first opening associated with the outlet tube at the second exchanger outlet, a second opening associated with the bypass outlet, and a third opening associated with an inlet to the downstream component;
a valve body mounted for pivoting movement within the valve housing, wherein the valve body has a first side and a second side opposite the first side, and wherein the valve body is moveable between at least a first position to close the outlet tube and a second position to close the bypass tube;
a first flap mounted on the first side, the first flap comprising a conical flap to be associated with the outlet tube;
a second flap mounted on the second side, the second flap and comprising a flat flap to be associated with the bypass tube;
a pivot shaft mounted within the valve housing, and wherein the valve body comprises a vane that is fixed for pivoting movement with the pivot shaft; and
a second shaft that extends between the first flap and the vane, wherein the second shaft has a first end associated with the first flap and a second end associated with the vane, wherein the second end comprises a spherical ball portion that fits within a spherical recess in the vane to allow the second shaft to pivot relative to the vane.

16-17. (canceled)

18. The vehicle exhaust component assembly according to claim 15, including a compliant member mounted around the second shaft adjacent to the spherical ball portion and a compliance housing enclosing the compliant member between an inner surface of the compliance housing and the first side of the vane.

19. (canceled)

20. The vehicle exhaust component assembly according to claim 15, wherein:
when the first flap seals the outlet tube and when the EGR valve is in the open position, exhaust gas flows through the heat exchanger to be cooled before entering the EGR pipe, and exhaust gas also flows through the bypass tube and into the downstream component;
when the first flap seals the outlet tube and when the EGR valve is in the closed position, exhaust gas only flows through the bypass tube;
when the second flap seals the bypass tube and when the EGR valve is in the open position, exhaust gas flows through the heat exchanger to be cooled before entering the EGR pipe, exhaust gas is prevented from flowing through the bypass tube, and exhaust gas flows through the heat exchanger and is subsequently directed into the downstream component; and
when the second flap seals the bypass tube and when the EGR valve is in the closed position, exhaust gas only flows through the heat exchanger and then into the downstream component, and exhaust gas is prevented from flowing through the bypass tube.

21. The vehicle exhaust component assembly according to claim 15, wherein the vane comprises a generally flat plate extending between a first edge that is fixed to the pivot shaft and an opposite edge, and wherein the first edge includes a curved portion that fits around the pivot shaft.

22. The vehicle exhaust component assembly according to claim 21, wherein the vane comprises a straight portion at the first edge that transitions into a rounded portion at the opposite edge, and wherein the rounded portion comprises a circular plate.

23. The vehicle exhaust component assembly according to claim 22, wherein the flat flap has a ring shape having an outer peripheral edge that aligns with an outer peripheral edge of the circular plate such the flat flap directly seals against a pipe planar end of the bypass tube.

24. The vehicle exhaust component assembly according to claim 1, wherein the vane comprises a generally flat plate extending between a first edge that is fixed to the pivot shaft and an opposite edge, and wherein the first edge includes a curved portion that fits around the pivot shaft.

25. The vehicle exhaust component assembly according to claim 1, wherein the vane comprises a straight portion at the first edge that transitions into a rounded portion at the opposite edge, and wherein the rounded portion comprises a circular plate.

26. The vehicle exhaust component assembly according to claim 25, wherein the flat flap has a ring shape having an outer peripheral edge that aligns with an outer peripheral edge of the circular plate such the flat flap directly seals against a pipe planar end of a bypass tube that provides the bypass.
